(19) United States
(12) Patent Application Publication
(10) Pub. No.: US 2014/0324838 A1
(43) Pub. Date: Oct. 30, 2014

(54) SERVER, CLIENT TERMINAL, SYSTEM, AND RECORDING MEDIUM

(71) Applicant: SONY CORPORATION, Tokyo (JP)

(72) Inventors: Yoichiro Sako, Tokyo (JP); Mitsuru Takehara, Tokyo (JP); Yasushi Miyajima, Kanagawa (JP)

(73) Assignee: SONY CORPORATION, Tokyo (JP)

(21) Appl. No.: 14/356,318

(22) PCT Filed: Nov. 19, 2012
(86) PCT No.: PCT/JP2012/079930

§ 371 Date: May 5, 2014

(30) Foreign Application Priority Data
Dec. 27, 2011 (JP) 2011-285204

(51) Int. Cl. G06F 17/30; H04N 1/00; H04L 29/08

(52) U.S. Cl. CPC G06F 17/30256; G06F 17/30554; H04L 67/18; H04N 1/00244
USPC 707/722; 707/769; 348/207.1

(57) ABSTRACT

Provided a server including a reception unit configured to receive information relating to a circumstance specified by a user with respect to a target from a client terminal, a search unit configured to search for an image of the target suitable for the circumstance specified by the user with respect to the target received by the reception unit, and a transmission unit configured to transmit the image searched for by the search unit to the client terminal.

### TECHNICAL FIELD

The present disclosure relates to a server, a client terminal, a system, and a recording medium.

### BACKGROUND ART

Recently, digital cameras that store and save a subject image as a digital image signal in a storage medium have been spread. These digital cameras record and save an image when the image is displayed on a viewfinder.

On the other hand, in the following Patent Literature 1, a digital camera capable of acquiring a past or future image of a specific target image is proposed. Specifically, when a user has specified a past date, the digital camera described in the following Patent Literature 1 uploads the specified date, position information of the digital camera, and the like to a server and acquires a corresponding past image from the server. The digital camera displays the acquired past image when a shutter button is pressed.

In addition, when a future date is specified and the shutter button is pressed by a user, the digital camera described in the following Patent Literature 1 uploads the specified future date, position information of the digital camera, and the like to the server and makes a reservation of an image search. Then, the server transmits a searched image based on each piece of information uploaded from the digital camera to the digital camera on the reserved date.

As described above, in the following Patent Literature 1, a past or a future image of a target image is acquired based on a past or future date specified by a user.

### CITATION LIST

### Patent Literature

Patent Literature 1: JP 2006-260338A

### SUMMARY OF INVENTION

### Technical Problem

However, in the technology disclosed in Patent Literature 1, a past or a future image is acquired through specification of a date, and thus a user should know an accurate date of a specific circumstance when he or she wants to see a captured image of the specific circumstance. For example, when the user wants to specify a specific circumstance such as when the user wants to see a night view of scenery (or a subject image) being viewed at present, wants to see scenery of autumn leaves, wants to see scenery of a blue sky, or wants to see a future appearance of a building being renovated at present, the user has to specify the accurate date of the circumstance. Such work burdens the user and there are cases in which the user does not know the accurate date.

Thus, the present disclosure proposes a novel and improved server, client terminal, system, and recording medium that can provide an image suitable for a circumstance specified by a user.

### Solution to Problem

According to the present disclosure, there is provided a server including a reception unit configured to receive information relating to a circumstance specified by a user with respect to a target from a client terminal, a search unit configured to search for an image of the target suitable for the circumstance specified by the user with respect to the target received by the reception unit, and a transmission unit configured to transmit the image searched for by the search unit to the client terminal.

According to the present disclosure, there is provided a client terminal including a transmission unit configured to transmit information relating to a circumstance specified by a user with respect to a target to a server, a reception unit configured to receive an image of the target suitable for the circumstance specified by the user from the server, and a display control unit configured to control display, based on the image of the target which is received by the reception unit and suitable for the circumstance specified by the user.

According to the present disclosure, there is provided a system including an image information storage unit configured to store an image of a target and meta-information indicating a circumstance of the target in association with each other, a search unit configured to search for meta-information indicating a circumstance suitable for a circumstance specified by a user with respect to the target from the image information storage unit and to set, as a search result, an image of the target corresponding to the meta-information that has been searched for, and a display control unit configured to control display, based on the image of the target searched for by the search unit.

According to the present disclosure, there is provided a recording medium having a program recorded thereon, the program causing a computer to execute a process of receiving information relating to a circumstance specified by a user with respect to a target from a client terminal, a process of searching for an image of the target suitable for the circumstance specified by the user with respect to the target received in the process of receiving, and a process of transmitting the image searched for in the process of searching to the client terminal.

According to the present disclosure, there is provided a recording medium having a program recorded thereon, the program causing a computer to execute a process of transmitting information relating to a circumstance specified by a user with respect to a target to a server, a process of receiving an image of the target suitable for the circumstance specified by the user from the server, and a process of controlling display, based on the image of the target received in the process of receiving.

According to the present disclosure, there is provided a recording medium having a program recorded thereon, the program causing a computer to execute a process of storing an image of a target and meta-information indicating a circumstance of the target in association with each other in an image information storage unit, a process of searching for the meta-information indicating a circumstance suitable for the circumstance with respect to the target specified by a user from the image information storage unit and setting, as a search result, an image of the target corresponding to the meta-information that has been searched for, and a process of controlling display, based on the image of the target searched for in the process of searching.

### Advantageous Effects of Invention

According to the aspects of the present disclosure described above, it is possible to provide an image suitable for a circumstance specified by a user.

### BRIEF DESCRIPTION OF DRAWINGS

FIG. 1 is a diagram for describing an overview of a time shift display system according to an embodiment of the present disclosure.

FIG. 2 is a block diagram showing a configuration of a server according to the embodiment of the present disclosure.

FIG. 3 is a block diagram showing a configuration of a digital camera according to the embodiment of the present disclosure.

FIG. 4 is a flowchart showing an operation process of a time shift display system according to the embodiment of the present disclosure.

FIG. 5 is a diagram showing a screen example showing a plurality of images of night views suitable for a specified circumstance in a day-night shift of the present disclosure.

FIG. 6 is a diagram for describing a season shift of the present disclosure.

FIG. 7 is a diagram for describing a case in which a circumstance is further specified using a cherry blossom dial in the season shift of the present disclosure.

FIG. 8 is a diagram for describing a weather shift of the present disclosure.

### DESCRIPTION OF EMBODIMENT

Hereinafter, a preferred embodiment of the present invention will be described in detail with reference to the appended drawings. Note that, in this specification and the drawings, elements that have substantially the same function and structure are denoted with the same reference signs, and repeated explanation is omitted.

In addition, description will be provided in the following order.

1. Overview of a time shift display system according to an embodiment of the present disclosure

2. Basic configuration

3. Operation process

4. Time shift of each circumstance
4-1. Day-night shift
4-2. Season shift
4-3. Weather shift
4-4. Construction shift

5. Conclusion

### 1. OVERVIEW OF A TIME SHIFT DISPLAY SYSTEM ACCORDING TO AN EMBODIMENT OF THE PRESENT DISCLOSURE

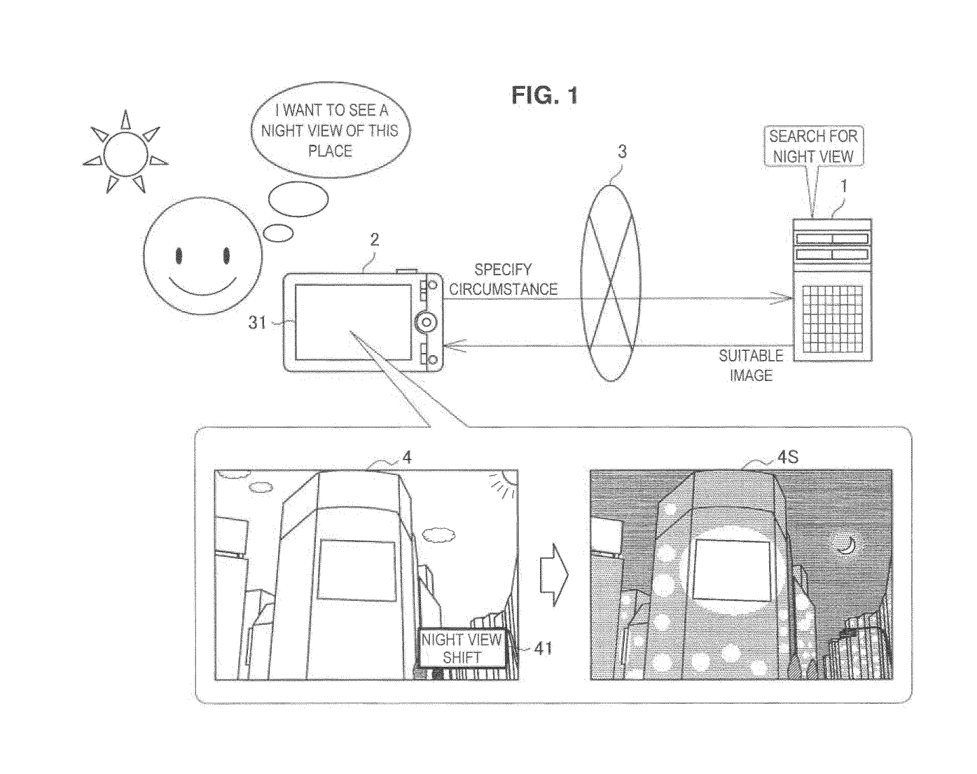

First, an overview of a time shift display system according to an embodiment of the present disclosure will be described with reference to FIG. 1. As shown in FIG. 1, the time shift display system according to the embodiment of the present disclosure has a server 1 and a digital camera 2 that is a client terminal. In addition, the server 1 and the digital camera 2 can be connected to each other via a network 3.

As shown in FIG. 1, when a user photographs a subject using the digital camera 2, there are cases in which the user wants to see not only a photographed image of a subject (target) being displayed at present on a display device 31 but also a subject image of a specific circumstance.

To be specific, when a user visits a tourist attraction, or the like, for example, there are cases in which the user is displeased because he or she is not able to enjoy desired sightseeing due to the time of the visit or weather, or is satisfied with present sightseeing but has a desire to see scenery under a different circumstance.

For example, there are user's desires such as:
“I have visited here in daytime, but what would a night view of this site look like?”
“I have visited here at night, but what would a daytime landscape look like?”
“I have visited here before the autumn leaves, but what would scenery of the autumn leaves look like?”
“What would a snowy landscape here look like?
“The mountains and lakes look blurry due to bad weather; what would a landscape on a clear day look like?
“The building is covered with a curtain due to renovation; what did the building look like before?”

In the example shown in FIG. 1, when a user performs photographing in daytime, for example, a present cityscape, i.e., in daytime (captured image 4), is displayed on the display device 31. However, there is a case in which the user also has a desire to see a night view of the cityscape.

Thus, according to the embodiment of the present disclosure, when the user selects a night view shift button 41 in a day-night shift mode to specify a circumstance of a target, an image 4S of the night view of the cityscape can be displayed in the digital camera 2 as shown in FIG. 1.

In such a time shift display system according to the embodiment of the present disclosure, satisfaction of a user can be raised by fulfilling a desire of the user. In addition, in the time shift display system according to the present embodiment, the user can see not only a present landscape but also a landscape of a desired circumstance (situation). In addition, the time shift display system according to the present embodiment is a preferred display system particularly for tourists.

In order to fulfill such a desire of a user, it is necessary for the digital camera 2 according to the present embodiment to acquire an image of a target suitable for a circumstance specified by the user from a network (to be provided with an image from the server 1). Hereinafter, the acquisition of the image 4S of the night view desired by the user will be briefly described using the example shown in FIG. 1.

As shown in FIG. 1, the digital camera 2 transmits information relating to a circumstance of a target specified by the user (here, specification of a night view and position information of the digital camera 2) to the server 1. The server 1 searches for a suitable image based on the information relating to the circumstance of the target.

To be specific, for example, the server 1 presumes the target that is a subject of the digital camera 2 based on the position information of the digital camera 2 and searches for an image (the image 4S of the night view of the presumed target) suitable for the circumstance (here, the night view) of the presumed target specified by the user.

Then, the server 1 transmits the searched image 4S of the night view to the digital camera 2. The digital camera 2 displays the received image 4S of the night view, and thereby the user can see the image of the target of the desired circumstance.

As described above, in the time shift display system according to the present embodiment, the digital camera 2 can acquire and display an image of a target suitable for a circumstance specified by a user from a network (be provided with the image from the server 1).

Hereinabove, the overview of the time shift display system according to the embodiment of the present disclosure has been described. Hereinbelow, configurations of the server 1 and the digital camera 2 (a client terminal) included in the time shift display system will be described in detail.

Note that, in FIG. 1, the digital camera 2 is exemplified as a client terminal, but a client terminal according to the present embodiment is not limited thereto, and may be, for example, a video camera, a smartphone equipped with a camera, a PDA (Personal Digital Assistants), a PC (Personal Computer), a mobile telephone, a portable music reproduction device, a portable video processing device, a portable game device, or the like. In addition, a client terminal according to the present embodiment is not limited to a device equipped with a camera, and any device that can acquire information with which a target is presumed can be applicable, for example, a device with GPS, or the like.

### 2. Basic configuration

### [2-1. Server 1]

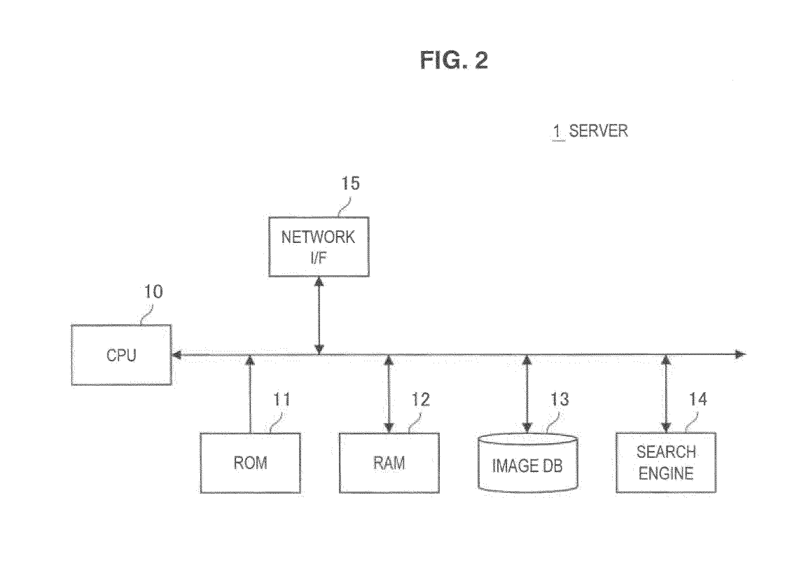

FIG. 2 is a block diagram showing a configuration of the server 1 according to the present embodiment. As shown in FIG. 1, the server 1 has a CPU 10, a ROM 11, a RAM 12, an image database (DB) 13, a search engine 14, and a network interface (I/F) 15. Hereinafter, each constituent element will be described.

### (Image DB 13)

The image DB 13 stores captured images in an associated state with meta-information including information of capturing times (year, month, day, hour, minute, and second), information of capturing places (position information, and latitude and longitude), information of capturing orientations, and the like.

In addition, the meta-information according to the present embodiment includes, in addition to the above examples, information of an altitude, an orientation, an angle of elevation, a distance to a target, a magnification of the digital camera 2, and a state of a target (a natural object or an artificial object) at the time of imaging, and a peripheral circumstance during photographing. Hereinafter, “a state of a target (a natural object or an artificial object)” and “a circumstance during photographing” will be further described using specific examples.

State of a Target (Natural Object)

Before start—start—30 percent—50 percent—80 percent—peak—post-peak—end

(A) When the target is cherry blossoms; green leaves—start blooming—30 percent bloom—half bloom—80 percent bloom—full bloom—start falling—fallen

(B) When the target is autumn leaves; green leaves—colors begin to change—50 percent—best time—fading—fallen

State of a Target (Artificial Object)

State of progress of construction work including construction, reconstruction, renovation, repairing, fixing, and the like of a building

(C) Broad categories; before construction—during construction—after construction

(D) Intermediate categories; before construction—initial state of construction—middle stage of construction—late stage of construction—after construction

Circumstance During Photographing

—Day-Night—

(E) Broad categories; morning—daytime—night

(F) Intermediate categories; sunrise—early morning—morning—noon—14 o'clock—early evening—sunset—evening—night—late night

—Season—

(G) Broad categories; spring—summer—autumn—winter

(H) Intermediate categories; early spring—spring—late spring—early summer—midsummer—late summer—early autumn—autumn—late autumn—early winter—winter—late winter

—Weather—

(I) Broad categories; clear—cloudy—rainy—snowy—foggy

(J) Intermediate categories; clear and sunny—clear—clear with heavy clouds—lightly cloudy—cloudy—rain clouds—light rain—rainy—heavy rain—thunderstorm

The various kinds of meta-information as described above may be meta-information added to the captured images stored in the image DB 13 in advance, may be acquired as analysis results of the captured images, or may be input by the user.

### (Search Engine 14)

The search engine 14 searches for an image suitable for information relating to a circumstance of a target specified by the user (hereinafter also referred to as specification information) received from the digital camera 2 among the images stored in the image DB 13.

Here, specification information includes at least information of a captured image of a target or photographing locations (position information of the digital camera 2). The search engine 14 may search for a suitable image from the image DB 13 by performing matching of a coincidence degree or a similarity degree of a captured image included in the specification information with an image stored in the image DB 13. In addition, the matching of the coincidence degree or the similarity degree of the images is performed using, for example, contour information of the images.

In addition, the search engine 14 may search for a suitable image from the image DB 13 by performing matching of the position information included in the specification information and position information of the photographing locations included in the meta-information stored in the image DB 13. When, for example, the position information included in the specification information is close to position information of Mount Fuji, the search engine 14 presumes the target to be Mount Fuji, and searches the image DB 13.

Furthermore, the specification information includes at least information representing a circumstance specified by the user. The search engine 14 searches for meta-information suitable for the information representing the circumstance specified by the user from the image DB 13, and sets an image of the target corresponding to the searched meta-information as a search result.

As described above, the search engine 14 searches for an image of the target based on the captured image of the target or/and position information included in the specification information, and further sets an image suitable for a circumstance specified by the user as a search result.

Furthermore, when the specification information includes an altitude, an orientation, an angle of elevation, the distance to the target, and a magnification of the digital camera 2 at the time of imaging, the search engine 14 can search for a suitable image having a more similar angle to a captured image photographed by the user based on the information.

### (Network I/F 15)

The network I/F 15 is a communication module for performing transmission and reception of data with the client terminal (digital camera 2) via the network 3. For example, the network I/F 15 according to the present embodiment receives the specification information from the digital camera 2 or transmits an image suitable for the specification information (search result) to the digital camera 2.

### (CPU 10, ROM 11, and RAM 12)

The ROM 11 stores a software program and the like for searching for a suitable image by the search engine 14 described above and transmitting a search result to the digital camera 2 which is a transmitting source of the specification information using the network I/F 15. The CPU 10 executes processes using the RAM 12 as a work area according to the software program stored in the ROM 11.

### [2-2. Digital Camera 2 (Client Terminal)]

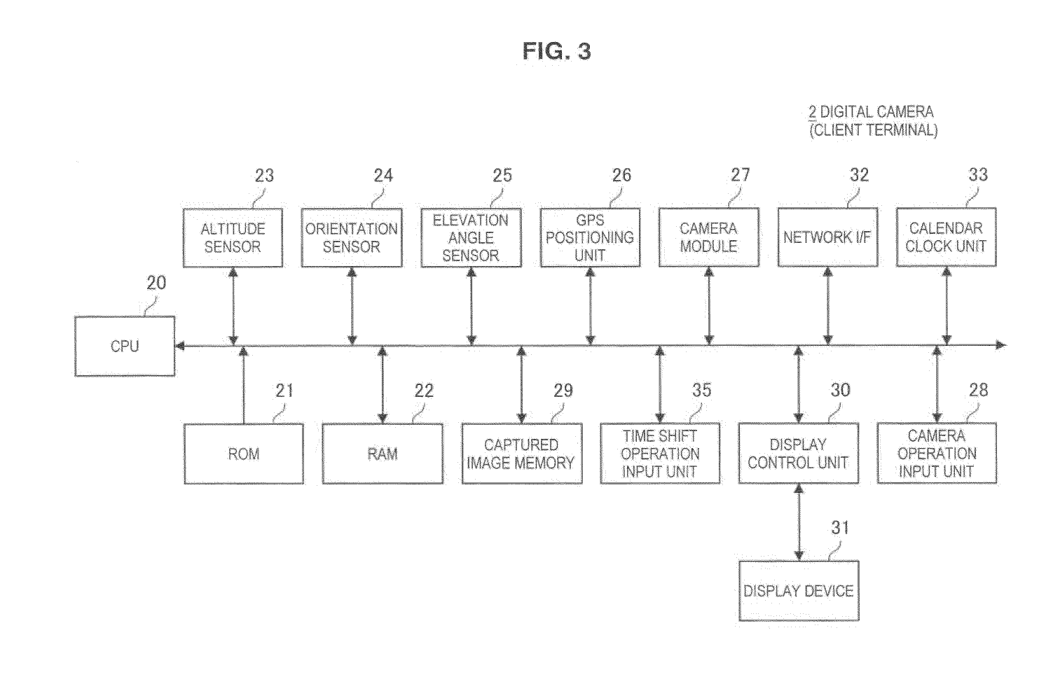

Next, a configuration of the client terminal will be described with reference to FIG. 3. The client terminal shown in FIG. 3 has a configuration of an imaging device having a function of wireless communication, i.e., the digital camera 2 in this example. Note that the present embodiment describes a case of a digital camera capturing still images, but a digital camera that can also image and record moving images may be possible.

As shown in FIG. 3, the digital camera 2 has a CPU 20, a ROM 32, a RAM 22, an altitude sensor 23, an orientation sensor 24, an elevation angle sensor 25, a GPS positioning unit 26, a camera module 27, a camera operation input unit 28, a captured image memory 29, a display control unit 30, a display device 31, a network interface (I/F) 32, and a time shift operation input unit 35. Hereinafter, each of the constituent elements will be described.

The ROM 21 stores programs for processes of transmitting the specification information to the server 1 and acquiring, displaying and recording a suitable image transferred from the server 1 according to the specification information and the like, in addition to a program for fulfilling an imaging function. The programs stored in the ROM 21 are executed by the CPU 20 using the RAM 22 as a work area.

The altitude sensor 23 senses an altitude of a present location in which the digital camera 2 is present, and outputs information of the sensed altitude.

The orientation sensor 24 senses a direction of an optical axis of a lens optical system of the camera module 27, i.e., an imaging direction, and outputs information of the sensed imaging direction.

The elevation angle sensor 25 senses an angle formed by the direction of the optical axis of the lens optical system of the camera module 27 and a horizontal plane (an angle of elevation or an inclination), i.e., an angle of a longitudinal direction of an imaging direction of the digital camera 2 (so-called imaging angle), and outputs information of the sensed imaging angle.

The GPS (Global Positioning System) positioning unit 26 senses a position in which the digital camera 2 is present by receiving radio waves from a GPS satellite, and outputs information of the sensed position. Note that the GPS positioning unit 26 is an example of an acquisition unit that acquires position information by sensing a position of the digital camera 2 based on a signal acquired from outside. An acquisition unit according to the present embodiment may be, for example, Wi-Fi, transmission and reception between a mobile telephone, a PHS, a smartphone, or the like or near-field communication, in addition to the GPS positioning unit 26.

In the present embodiment, the altitude information from the altitude sensor 23, the imaging direction information from the orientation sensor 24, the information of the imaging angle from the elevation angle sensor 25, and the position information from the GPS positioning unit 26 are recorded together with a captured image in the captured image memory 29 as meta-information of the captured image.

The camera module 27 includes an imaging sensor, an image optical system including imaging lenses, and a captured image signal processing unit, and outputs data of the captured image that have been turned into digital signals. Note that the image sensor is realized by, for example, a CCD (Charge Coupled Device) imager or a CMOS (Complementary Metal Oxide Semiconductor) imager. In addition, the camera module 27 outputs information of a magnification at the time of imaging, and in the present embodiment, the information of a magnification at the time of imaging is stored in the captured image memory 29 as meta-information of the captured image.

The camera operation input unit 28 includes a group of keys including a zoom key, a shutter button, and the like operated for imaging. The CPU 20 monitors what key is being operated in the camera operation input unit 28, and executes a process according to the operated key in a program of the ROM 21.

The display control unit 30 controls display of display content of a display screen displayed on the display device 31 connected thereto under control of the CPU 20 based on a program of the ROM 21. The display device 31 is realized by an LCD (Liquid Crystal Display), an OLED (Organic Light-Emitting Diode), a CRT (Cathode Ray Tube), or the like.

A calendar clock unit 33 is a unit that generates calendar clock information of year, month, day, hour, minute, and second. The calendar clock information is saved as imaging time information at the time of imaging. In addition, when a timer operation is performed, a set time is measured based on time information from the calendar clock unit 33.

The network I/F 27 is a communication module for performing transmission and reception of data with the server 1 via the network 3. For example, the network I/F 27 according to the present embodiment transmits the specification information to the server 1 or receives a suitable image according to the specification information (search result) from the server 1.

As the captured image memory 29, for example, a flash memory, such as a card-type memory is used. In addition, it may be a recording medium such as a DVD (Digital Versatile Disc). Furthermore, a hard disk device may be used rather than such a removable memory. In addition, the captured image memory 29 records, together with the captured image output from the camera module 27, altitude information, imaging direction (orientation) information, information of imaging angles (angles of elevation), position information, magnifications, and the like as meta-information of the captured image.

The time shift operation input unit 35 is a switch, a button, a dial, and the like which are used when a user specifies a circumstance of a target. Using the time shift operation input unit 35, the user specifies a desired circumstance of day and night, a season, weather, progress of construction, and the like. Information of a circumstance specified by the user and input by the time shift operation input unit 35 is transmitted from the network I/F 32 to the server 1 together with the captured image and the meta-information of the captured image.

Note that the switch, the button, the dial, and the like constituting the time shift operation input unit 35 may be physical ones, or images displayed on the display device 31. In the present embodiment, a touch panel that can sense operation inputs made by the user is provided to be laminated on the display device 31. Accordingly, the user can operate the button and the like displayed for a time shift operation input to specify a circumstance.

Hereinabove, the configuration of the client terminal (digital camera 2) according to the embodiment of the present disclosure has been described in detail. Next, a detailed operation process of the time shift display system according to the present embodiment will be described.

### 3. OPERATION PROCESS

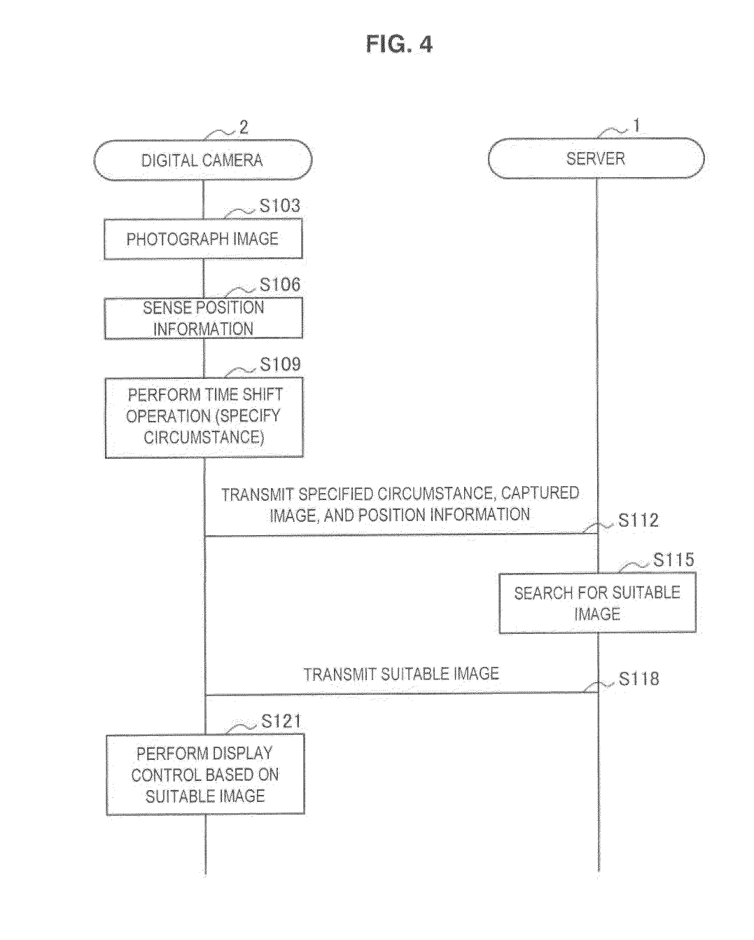

As described above, in the time shift display system according to the present embodiment, the digital camera 2 acquires an image suitable for a circumstance specified by a user on a network and displays the image. Such an operation process of the time shift display system will be described with reference to FIG. 4.

FIG. 4 is a flowchart showing the operation process of the time shift display system according to the present embodiment. As shown in FIG. 4, first, the digital camera 2 performs an image photographing process in Step S103. To be specific, when a user presses a shutter button (not shown), a target is imaged using the camera module 27, and a captured image output from the camera module 27 is stored in the captured image memory 29, and further is displayed on the display device 31.

Next, the digital camera 2 senses a current position in which the digital camera 2 is present using the GPS positioning unit 26 in Step S106, and stores position information output from the GPS positioning unit 26 in the captured image memory 29 as meta-information of the image captured in Step S103 described above.

Next, when a user specifies a circumstance of a target (subject) using the time shift operation input unit 35 in Step S109, the digital camera 2 transmits information relating to the circumstance specified by the user to the server 1 in the next Step S112. The information relating to the circumstance specified by the user is, for example, the captured image, the position information, and information of the specified circumstance.

Next, in Step S115, the server 1 searches for an image of the target suitable for the circumstance specified by the user from the image DB 13 of the server 1 based on the information relating to the circumstance specified by the user that has been received from the digital camera 2.

Next, in Step S118, the server 1 transmits the searched suitable image to the digital camera 2 that is a transmission source of the information relating to the circumstance specified by the user.

Next, in Step S121, the digital camera 2 performs display control based on the suitable image received from the server 1, thereby displaying the image of the target in the circumstance specified by the user.

Note that, in Step S115, when it is not possible to search for the image of the target suitable for the circumstance specified by the user from the image DB 13, the server 1 may transmit, to the digital camera 2, the fact that no suitable image has been found in Step S118. In this case, the digital camera 2 displays that no suitable image has been found to notify the user to that effect in Step S121.

Hereinabove, the operation process of the time shift display system according to the present embodiment has been described in detail. Next, what kind of circumstance can be specified by the user in the time shift operation in Step S109 described above will be described hereinbelow using a specific example.

### 4. TIME SHIFT OF EACH CIRCUMSTANCE

As described above, the user can specify a desired circumstance among day-night, seasons, weather, and the like as specification of a circumstance of a target. Hereinafter, specific examples of time shifts by which a present captured image changes through specification of a circumstance by a user will be described.

### [4-1. Day-Night Shift]

In a day-night shift, classification of time slots of one day such as day view or night view can be specified. For example, when a user arrives at Hakodate, which is a tourist attraction in day time, there is a case in which the user wonders, “What would the night view look like? I should come again at night if it's nice.”

Thus, if the user specifies a night view from the time shift operation input unit 35, the digital camera 2 acquires an image suitable for the circumstance specified for the target, i.e., an image of a past night view of Hakodate in this case, from the server 1, and displays the image. Accordingly, the user can view the desired night view image of Hakodate.

### (Night View Shift Button)

Here, the time shift operation input unit 35 for specifying the night view may be, for example, the night view shift button 41 as shown in FIG. 1. In addition, when the digital camera 2 determines that classification of a present time slot falls into daytime based on an analysis result of time information or a captured image in the day-night shift mode, only the night view shift button 41 may be displayed as a day-night switch button as shown in FIG. 1.

In addition, it is possible to specify morning or specify sunrise, early morning, sunset, and the like using the time shift operation input unit 35 by further subdividing the classification of the time slots, in addition to the specification of day-night described above.

### (Plural Display)

In addition, when the digital camera 2 receives a plurality of images suitable for the circumstance specified for a target from the server 1, the plurality of suitable images may be displayed on the display device 31.

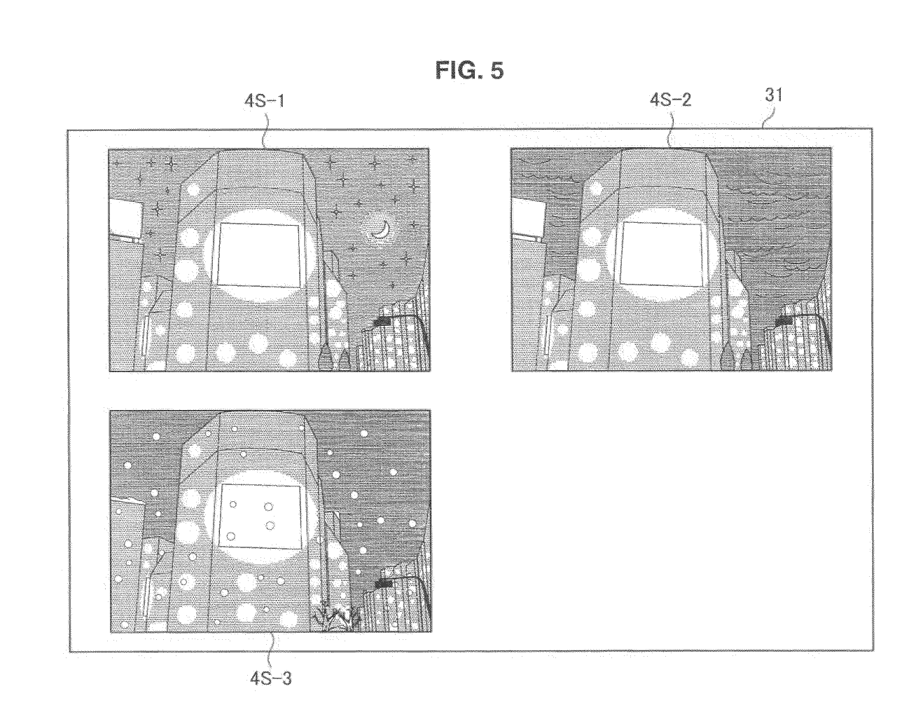

For example, a plurality of images of past night views suitable for specification of night view for a target which are 4S-1, 4S-2 and 4S-3 may be displayed on one screen as shown in FIG. 5, or may be displayed in a slide show.

### [4-2. Season Shift]

In a season shift, it is possible to specify a circumstance of a season including spring, summer, autumn, and winter. For example, when a user visits Kyoto's Arashiyama, which is a tourist attraction, in summer 2011, there is a case in which a user wonders, “What would autumn leaves look like here? I might want to visit Kyoto again in autumn.”

Thus, if the user specifies autumn using the time shift operation input unit 35, the digital camera 2 acquires an image suitable for the circumstance specified for the target, for example, an image of a past autumn of Kyoto's Arashiyama in this case, from the server 1 and displays the image. Accordingly, the user can view the desired autumn image of Arashiyama.

### (Season Shift Button)

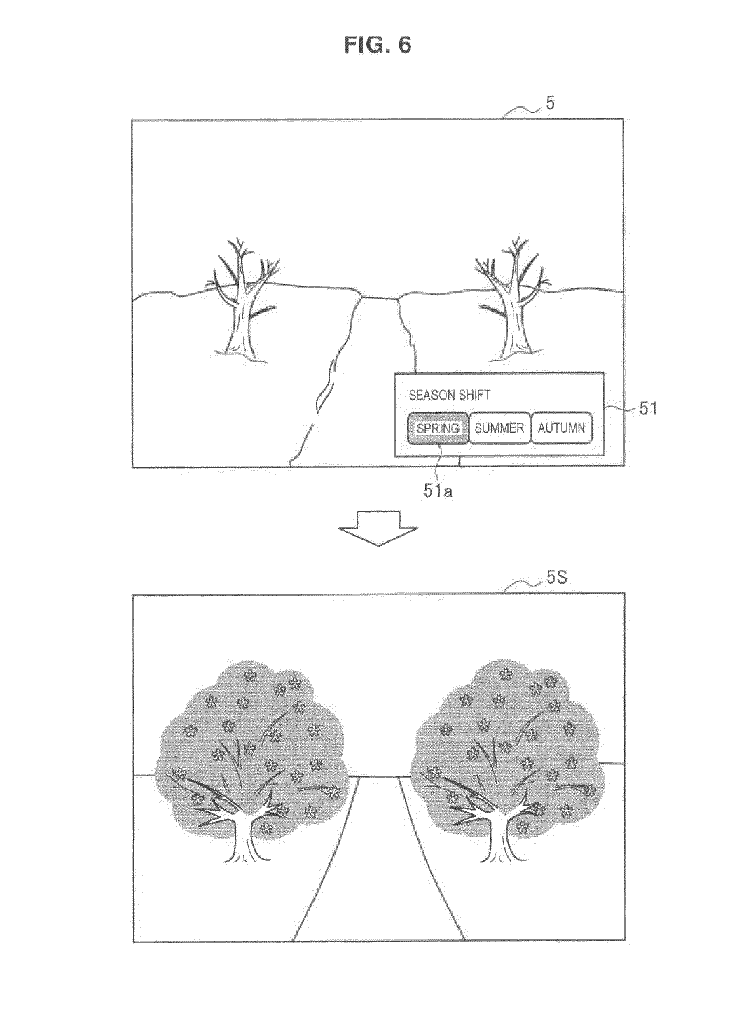

Here, the time shift operation input unit 35 for specifying a season may be, for example, a season shift button 51 as shown in FIG. 6. In addition, when the digital camera 2 determines that a current season is winter based on an analysis result of time information or a captured image in the season shift mode, the season shift button 51 only for “spring, summer, and autumn,” excluding “winter,” may be displayed as a season switch button as shown in FIG. 6.

When a spring shift button 51a is selected from the season shift button 51, for example, an image 5S of a past spring of the place where the user is which has been acquired from the server 1 is displayed instead of a captured image 5 of a present time, i.e., winter, as shown in FIG. 6.

In addition, a series of images that includes a circumstance specified by a user may be acquired to be displayed on one screen side by side, or may be displayed in a slide show. Accordingly, the user can view changes of seasons of the place where the user is. Note that “a series of images” may be a plurality of still images, or may be one or a plurality of moving images.

In addition, it may be possible to specify early summer, midsummer, late summer, and the like by further subdividing a season using the time shift operation input unit 35 in addition to specification of spring, summer, autumn, and winter described above.

### (Cherry Blossom Dial)

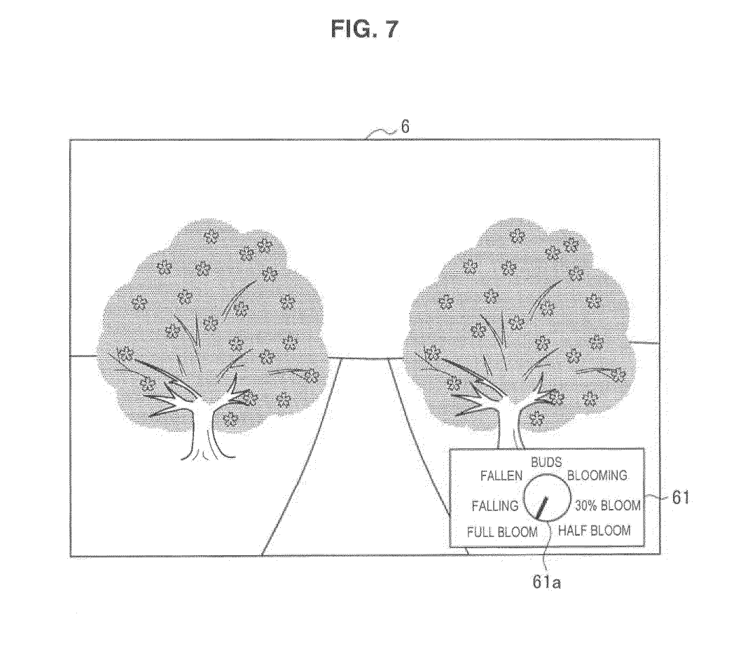

In addition, the time shift operation input unit 35 in accordance with a target may be realized so that a circumstance can be specified by further subdividing a season. For example, when a target is a cherry tree, a captured image 6 of a cherry tree may be displayed together with a cherry blossom dial 61 as shown in FIG. 7 so as to specify “buds—start blooming—30 percent bloom—half bloom—full bloom—start falling—fallen.” A user can specify a circumstance of cherry blossoms as the user turns a dial 61a of the cherry blossom dial 61 through a touch operation.

In addition, in the same manner, the time shift operation input unit 35 may be realized by a verdure dial if a target is verdure, or by an autumn leaf dial if a target is autumn leaves.

### [4-3. Weather Shift]

In a weather shift, a circumstance of weather including clear skies, clouds, rain, and the like can be specified. For example, when a user visits Lake Mashu in Hokkaido that is a tourist attraction and Lake Mashu is shrouded in fog, there is a case in which the user thinks, “I know ‘foggy Lake Mashu’ is famous but I would also like to see Lake Mashu under a blue sky.”

Thus, if the user specifies “clear” using the time shift operation input unit 35, the digital camera 2 acquires an image suitable for the circumstance specified for the target, i.e., an image of a past clear day at Lake Mashu in Hokkaido in this case from the server 1, and displays the image. Accordingly, the user can view the desired image of a clear day at Lake Mashu.

### (Weather Shift Button)

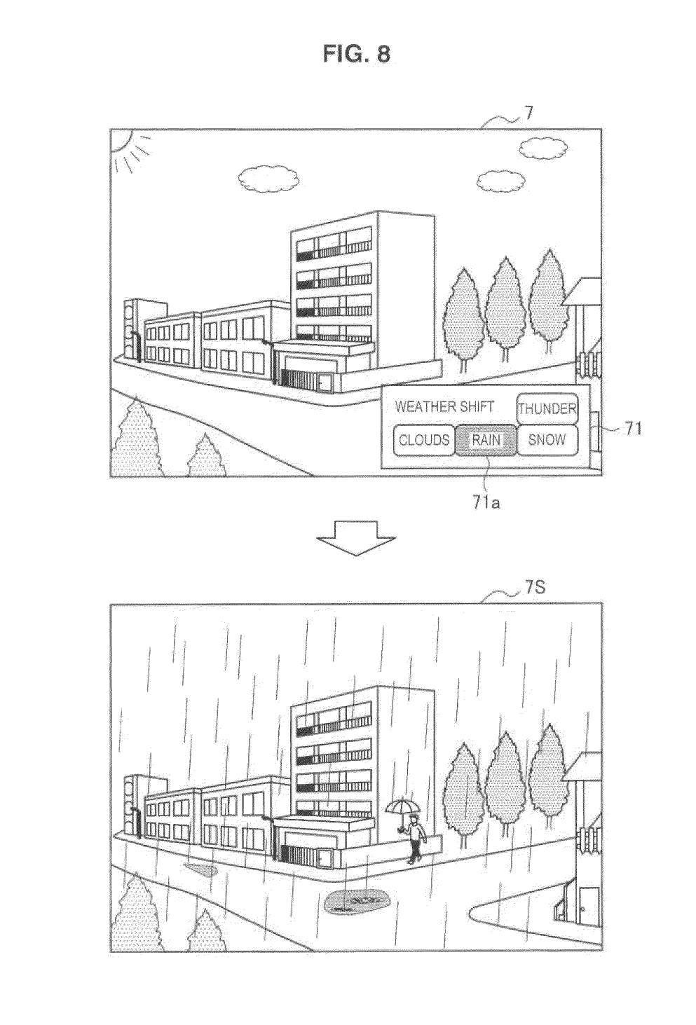

Here, the time shift operation input unit 35 for specifying weather may be, for example, a weather shift button 71 as shown in FIG. 8. In addition, when the digital camera 2 determines that present weather is clear based on an analysis result of time information or a captured image in the weather shift mode, the weather shift button 71 only for “cloudy, rainy, snowy, and thunder,” excluding “clear,” may be displayed as a weather switch button as shown in FIG. 8.

When a rain shift button 71a is selected from the weather shift button 71, for example, an image 7S of a past rainy day of the place where the user is which has been acquired from the server 1 is displayed instead of a captured image 7 of a present time, i.e., a clear day as shown in FIG. 8.

### [4-4. Construction Shift]

In a construction shift, progress of construction including before construction, during construction, after construction, and the like can be specified. Here, construction of the present specification broadly includes renovation, refurbishing, reconstruction, new construction, and the like of a building.

When a user visits Himeji Castle in Hyogo Prefecture that is a tourist attraction and Himeji Castle is in the middle of renovation, the user may think, “I want to see a whole picture of the famous castle also known as Hakuro Castle.”

Thus, when the user specifies the progress before the renovation using the time shift operation input unit 35, the digital camera 2 acquires an image suitable for the circumstance specified for the target, i.e., an image before the renovation of Himeji Castle (whole image of Himeji Castle) in this case, from the server 1 and displays the image. In addition, a completion-expected photo or a completion-expected illustration after the renovation of Himeji Castle may be displayed. Accordingly, the user can view the desired entire picture of Himeji Castle.

### 5. CONCLUSION

As described above, in the time shift display system according to the present embodiment, an image suitable for a circumstance of a target specified by a user in the digital camera 2 is provided from the server 1, and then can be displayed in the digital camera 2. Accordingly, it is possible to provide not only a present landscape but also a landscape of a circumstance (situation) desired by the user.

The preferred embodiment of the present disclosure has been described above with reference to the accompanying drawings, whilst the present disclosure is not limited to the above examples, of course. A person skilled in the art may find various alterations and modifications within the scope of the appended claims, and it should be understood that they will naturally come under the technical scope of the present disclosure.

For example, an image that the digital camera 2 acquires from the server 1 as described above is not limited to a still image, and may be, for example, a moving image.

In addition, an acquisition source of a suitable image is not limited to the specific server 1 as shown in FIG. 1, and may be a large indefinite number of servers and PCs (personal computers) having the functions of the image DB 13 and the search engine 14.

In addition, in the examples described above, the display control unit 30 of the digital camera 2 displays a suitable image acquired from the server 1 instead of a captured image. However, display control according to the present embodiment is not limited thereto, and the display control unit 30 may, for example, clip out a part of a captured image such as a person from the captured image and combine the part with a suitable image for display. In addition, the display control unit 30 may adjust an angle of a suitable image or the like in accordance with a captured image for display. By processing a suitable image acquired from the server 1 for display in this manner, an image in which a circumstance different from the present (past or future of the image) appears to be photographed in stark reality can be displayed

In addition, in the operation process described with reference to FIG. 4, the user specifies a specific circumstance for the target after the target is imaged through pressing of the shutter button, but the operation process according to the present embodiment is not limited thereto. For example, when the shutter button is pressed after a circumstance is specified in each shift mode in advance (the day-night shift, season shift, weather shift, and the like), the digital camera 2 transmits a captured image, specification information, and the like to the server 1 and then displays a suitable image acquired from the server 1. Accordingly, the user can have a feeling that the target is photographed in the desired circumstance by pressing the shutter button.

In addition, the configuration of the client terminal according to the present embodiment is not limited to the example shown in FIG. 3. For example, the client terminal may further have an image DB and a search engine. The client terminal having such a configuration can search for an image suitable for a circumstance specified by a user from the image DB included in the client terminal and can perform display control with respect to the searched suitable image.

Additionally, the present technology may also be configured as below.

(1)

A server including:

a reception unit configured to receive information relating to a circumstance specified by a user with respect to a target from a client terminal;

a search unit configured to search for an image of the target suitable for the circumstance specified by the user with respect to the target received by the reception unit; and

a transmission unit configured to transmit the image searched for by the search unit to the client terminal.

(2)

The server according to (1),

wherein the information relating to the circumstance specified by the user with respect to the target includes position information of the client terminal, and

wherein the search unit searches for the image of the target by matching the position information of the client terminal with position information of the target associated with the image of the target.

(3)

The server according to (2),

wherein the information relating to the circumstance specified by the user with respect to the target further includes information of an orientation, an altitude, an angle of elevation or a magnification of the client terminal, and

wherein the search unit searches for the image of the target based on the information of the orientation, the altitude, the angle of elevation or the magnification of the client terminal in addition to the matching of the position information.

(4)

The server according to any one of (1) to (3),

wherein the information relating to the circumstance specified by the user with respect to the target includes a captured image of the target imaged by the client terminal, and

wherein the search unit searches for the image of the target by matching of a coincidence degree or a similarity degree of the captured image and the image of the target.

(5)

The server according to (4), wherein the matching of the coincidence degree or the similarity degree is performed using contour information of the images.

(6)

The server according to any one of (1) to (5),

wherein the information relating to the circumstance specified by the user with respect to the target includes position information of the client terminal and a captured image of the target imaged by the client terminal, and

wherein the search unit searches for the image of the target based on matching of the position information of the client terminal and position information of the target associated with the image of the target and matching of a coincidence degree or a similarity degree of the captured image and the image of the target.

(7)

The server according to any one of (1) to (6),

wherein the information relating to the circumstance specified by the user with respect to the target includes information of specification of classification of time slots, season specification, weather specification, or construction progress specification with respect to the target.

(8)

The server according to any one of (1) to (7),

wherein, when the search unit fails to search for the image of the target, the transmission unit transmits, to the client terminal, the fact that no suitable image of the target has been found.

(9)

A client terminal including:

a transmission unit configured to transmit information relating to a circumstance specified by a user with respect to a target to a server;

a reception unit configured to receive an image of the target suitable for the circumstance specified by the user from the server; and

a display control unit configured to control display, based on the image of the target which is received by the reception unit and suitable for the circumstance specified by the user.

(10)

The client terminal according to (9), further including:

an acquisition unit configured to acquire position information of the client terminal, based on a signal acquired from outside,

wherein the transmission unit transmits the position information acquired by the acquisition unit with the position information included in the information relating to the circumstance specified by the user.

(11)

The client terminal according to (9) or (10),

wherein the reception unit receives a plurality of images of the target suitable for the circumstance specified by the user from the server, and

wherein the display control unit controls display, based on the plurality of images.

(12)

The client terminal according to any one of (9) to (10),

wherein the reception unit receives images of a series of courses of the target suitable for the circumstance specified by the user from the server, and

wherein the display control unit controls display, based on the images of the series of courses.

(13)

The client terminal according to any one of (9) to (12), further including:

an imaging unit configured to acquire a captured image of the target,

wherein the transmission unit transmits the captured image acquired by the imaging unit with the captured image included in the information relating to the circumstance specified by the user.

(14)

The client terminal according to (13), wherein the display control unit extracts a part of the captured image from the captured image, combines the extracted part of the captured image with the image of the target suitable for the circumstance specified by the user, and displays the combined image.

(15)

The client terminal according to any one of (9) to (14), further including:

an operation input unit through which the circumstance with respect to the target is specified,

wherein the transmission unit transmits information of the circumstance specified by the user through the operation input unit with the information included in the information relating to the circumstance specified by the user.

(16)

A system including:

an image information storage unit configured to store an image of a target and meta-information indicating a circumstance of the target in association with each other;

a search unit configured to search for meta-information indicating a circumstance suitable for a circumstance specified by a user with respect to the target from the image information storage unit and to set, as a search result, an image of the target corresponding to the meta-information that has been searched for; and

a display control unit configured to control display, based on the image of the target searched for by the search unit.

(17)

A recording medium having a program recorded thereon, the program causing a computer to execute:

a process of receiving information relating to a circumstance specified by a user with respect to a target from a client terminal;

a process of searching for an image of the target suitable for the circumstance specified by the user with respect to the target received in the process of receiving; and

a process of transmitting the image searched for in the process of searching to the client terminal.

(18)

A recording medium having a program recorded thereon, the program causing a computer to execute:

a process of transmitting information relating to a circumstance specified by a user with respect to a target to a server;

a process of receiving an image of the target suitable for the circumstance specified by the user from the server; and

a process of controlling display, based on the image of the target received in the process of receiving.

(19)

A recording medium having a program recorded thereon, the program causing a computer to execute:

a process of storing an image of a target and meta-information indicating a circumstance of the target in association with each other in an image information storage unit;

a process of searching for the meta-information indicating a circumstance suitable for the circumstance with respect to the target specified by a user from the image information storage unit and setting, as a search result, an image of the target corresponding to the meta-information that has been searched for; and

a process of controlling display, based on the image of the target searched for in the process of searching.

### REFERENCE SIGNS LIST

1 server
2 digital camera (client terminal)
3 network
4, 5, 6, 7 captured image
4S, 4S-1, 4S-2, 4S-3 night view image
13 image database (DB)
14 search engine
15, 32 network interface (I/F)
23 altitude sensor
24 orientation sensor
25 elevation angle sensor
26 GPS positioning unit
27 camera module
28 camera operation input unit
29 captured image memory
30 display control unit
31 display device
32 calendar clock unit
35 time shift operation input unit
41 night view shift button
51 season shift button
71 weather shift button

1. A server comprising:
a reception unit configured to receive information relating to a circumstance specified by a user with respect to a target from a client terminal;
a search unit configured to search for an image of the target suitable for the circumstance specified by the user with respect to the target received by the reception unit; and
a transmission unit configured to transmit the image searched for by the search unit to the client terminal.

2. The server according to claim 1,
wherein the information relating to the circumstance specified by the user with respect to the target includes position information of the client terminal, and
wherein the search unit searches for the image of the target by matching the position information of the client terminal with position information of the target associated with the image of the target.

3. The server according to claim 2,
wherein the information relating to the circumstance specified by the user with respect to the target further includes information of an orientation, an altitude, an angle of elevation or a magnification of the client terminal, and
wherein the search unit searches for the image of the target based on the information of the orientation, the altitude, the angle of elevation or the magnification of the client terminal in addition to the matching of the position information.

4. The server according to claim 1,
wherein the information relating to the circumstance specified by the user with respect to the target includes a captured image of the target imaged by the client terminal, and
wherein the search unit searches for the image of the target by matching of a coincidence degree or a similarity degree of the captured image and the image of the target.

5. The server according to claim 4, wherein the matching of the coincidence degree or the similarity degree is performed using contour information of the images.

6. The server according to claim 1,
wherein the information relating to the circumstance specified by the user with respect to the target includes position information of the client terminal and a captured image of the target imaged by the client terminal, and
wherein the search unit searches for the image of the target based on matching of the position information of the client terminal and position information of the target associated with the image of the target and matching of a coincidence degree or a similarity degree of the captured image and the image of the target.

7. The server according to claim 1,
wherein the information relating to the circumstance specified by the user with respect to the target includes information of specification of classification of time slots, season specification, weather specification, or construction progress specification with respect to the target.

8. The server according to claim 1,
wherein, when the search unit fails to search for the image of the target, the transmission unit transmits, to the client terminal, the fact that no suitable image of the target has been found.

9. A client terminal comprising:
a transmission unit configured to transmit information relating to a circumstance specified by a user with respect to a target to a server;
a reception unit configured to receive an image of the target suitable for the circumstance specified by the user from the server; and
a display control unit configured to control display, based on the image of the target which is received by the reception unit and suitable for the circumstance specified by the user.

10. The client terminal according to claim 9, further comprising:
an acquisition unit configured to acquire position information of the client terminal, based on a signal acquired from outside,
wherein the transmission unit transmits the position information acquired by the acquisition unit with the position information included in the information relating to the circumstance specified by the user.

11. The client terminal according to claim 9,
wherein the reception unit receives a plurality of images of the target suitable for the circumstance specified by the user from the server, and
wherein the display control unit controls display, based on the plurality of images.

12. The client terminal according to claim 9,
wherein the reception unit receives images of a series of courses of the target suitable for the circumstance specified by the user from the server, and
wherein the display control unit controls display, based on the images of the series of courses.

13. The client terminal according to claim 9, further comprising:
an imaging unit configured to acquire a captured image of the target,
wherein the transmission unit transmits the captured image acquired by the imaging unit with the captured image included in the information relating to the circumstance specified by the user.

14. The client terminal according to claim 13, wherein the display control unit extracts a part of the captured image from the captured image, combines the extracted part of the captured image with the image of the target suitable for the circumstance specified by the user, and displays the combined image.

15. The client terminal according to claim 9, further comprising:
an operation input unit through which the circumstance with respect to the target is specified,
wherein the transmission unit transmits information of the circumstance specified by the user through the operation input unit with the information included in the information relating to the circumstance specified by the user.

16. A system comprising:
an image information storage unit configured to store an image of a target and meta-information indicating a circumstance of the target in association with each other;
a search unit configured to search for meta-information indicating a circumstance suitable for a circumstance specified by a user with respect to the target from the image information storage unit and to set, as a search result, an image of the target corresponding to the meta-information that has been searched for; and
a display control unit configured to control display, based on the image of the target searched for by the search unit.

17. A recording medium having a program recorded thereon, the program causing a computer to execute:
a process of receiving information relating to a circumstance specified by a user with respect to a target from a client terminal;
a process of searching for an image of the target suitable for the circumstance specified by the user with respect to the target received in the process of receiving; and
a process of transmitting the image searched for in the process of searching to the client terminal.

18. A recording medium having a program recorded thereon, the program causing a computer to execute:
a process of transmitting information relating to a circumstance specified by a user with respect to a target to a server;
a process of receiving an image of the target suitable for the circumstance specified by the user from the server; and
a process of controlling display, based on the image of the target received in the process of receiving.

19. A recording medium having a program recorded thereon, the program causing a computer to execute:
a process of storing an image of a target and meta-information indicating a circumstance of the target in association with each other in an image information storage unit;
a process of searching for the meta-information indicating a circumstance suitable for the circumstance with respect to the target specified by a user from the image information storage unit and setting, as a search result, an image of the target corresponding to the meta-information that has been searched for; and
a process of controlling display, based on the image of the target searched for in the process of searching.
